(19) United States
(12) Patent Application Publication
(10) Pub. No.: US 2026/0322233 A1
(43) Pub. Date: Oct. 15, 2026

(54) COIL SUPPORT ASSEMBLY HAVING COIL SUPPORT STRUCTURES JOINED TOGETHER VIA RESPECTIVE JOINT STRUCTURES AND METHODS OF ASSEMBLING SAME

(71) Applicants: David Allan TORREY, Niskayuna, NY (US); GE Vernova Renovables Espana, S.L., Barcelona (ES)

(72) Inventors: David Allan Torrey, Galway, NY (US); Dhanushkodi Durai Mariappan, Albany, NY (US); Jacob Johannes Nies, Hertme (NL); James William Bray, Niskayuna, NY (US); Anbo Wu, Clifton Park, NY (US); Paul Mathew, Bengaluru (IN); Bruno Gaston Jean Crepel, Bavilliers (FR)

(21) Appl. No.: 19/479,043

(22) PCT Filed: Apr. 28, 2023
(86) PCT No.: PCT/US2023/020303

§ 371 Date: Oct. 27, 2025

(51) Int. Cl. H02K 55/02; F03D 9/25; F03D 15/20; H02K 7/18; H02K 15/085

(52) U.S. Cl. CPC H02K 55/02; H02K 7/1838; H02K 15/085; F03D 9/25; F03D 15/20; F05D 2220/76

(57) ABSTRACT

An electrical machine is provided. The electrical machine includes a coil support assembly including a plurality of coil support structures for receiving a plurality of conducting coils, the plurality of coil support structures arranged together in a generally circumferential arrangement. Each of the plurality of coil support structures includes a first face defining a cavity for receiving one of the plurality of conducting coils and opposing sides each including a joint component. Further, the joint components of adjacent coil support structures include corresponding male and female joint components secured together at a joint structure.

### RELATED APPLICATION

The present application claims priority to PCT Application No. PCT/US2023/020303, filed Apr. 28, 2023, which is incorporated by reference herein in its entirety.

### STATEMENT REGARDING FEDERALLY SPONSORED RESEARCH OR DEVELOPMENT

This invention was made with Government support under Contract No. DE-EE0008787 awarded by the Department of Energy (DOE). The Government has certain rights in the invention.

### FIELD

The present disclosure relates generally to superconducting machines and, more particularly, to a coil support assembly for a superconducting machine formed of coil support structures joined together via respective joint structures.

### BACKGROUND

Generally, superconducting machines, such as superconducting generators and superconducting motors, include a plurality of superconducting coils for generating a static or rotating magnetic field and at least one armature coil for generating a rotating magnetic field or a stationary magnetic field in relation to the motion of the armature that interacts with the field from the superconducting coils. Wind turbine superconducting generators generally include a main shaft, an armature with at least one armature winding arranged with respect to the main shaft, and a coil support assembly including a plurality of superconducting coils secured thereto. The superconducting coils (which typically carry a direct current) are typically constructed of a superconducting material (“superconductor”) instead of conventionally conducting material with an electrical resistance (e.g., copper, aluminum, etc.).

The current-carrying capacity of superconducting materials in their superconducting state is typically over an order of magnitude higher than that of traditional conductors such aluminum or copper at room temperature, particularly in DC operation or low frequency. Thus, the use of superconductors in power applications, such as wind turbine generators, provides numerous benefits, including but not limited to more efficient performance, non-gearbox direct drive operation, potentially reduced manufacturing and installation costs, and/or lower generator weight as a result of the stronger magnetic fields requiring less ferromagnetic material to direct the magnetic fields. Such benefits are particularly useful for offshore wind turbine applications.

However, mechanical interactions can occur as a result of placing superconducting coils in close proximity to each other. Moreover, assembly complications can occur as a result of assembling a coil support assembly for the superconducting coils having components and/or fasteners that cause electromagnetic interference or mechanical interactions with each other. In particular, the mechanical interactions between the superconducting coils are tied to the proximity of the coils. The electromagnetic interference and/or mechanical interactions between the superconducting coils and the coil support assembly are tied to the materials of the assembly.

As a result of this, it would be advantageous to reduce electromagnetic interference and/or mechanical interactions between the superconducting coils and the coil support assembly and amongst the superconducting coils. Accordingly, the present disclosure is directed to an improved coil support assembly of a superconducting machine and methods of assembling same that address the aforementioned issues.

### BRIEF DESCRIPTION

Aspects and advantages of the disclosure will be set forth in part in the following description, or may be obvious from the description, or may be learned through practice of the disclosure.

In one aspect, the present disclosure is directed to an electrical machine. The electrical machine includes a coil support assembly including a plurality of coil support structures for receiving a plurality of conducting coils, the plurality of coil support structures arranged together in a generally circumferential arrangement, wherein each of the plurality of coil support structures includes: a first face defining a cavity for receiving one of the plurality of conducting coils; and opposing sides each including a joint component, wherein joint components of adjacent coil support structures include corresponding male and female joint components secured together at a joint structure.

In an embodiment, the joint structure includes a dovetail joint.

In another embodiment, the joint structure defines at least one gap between the male and female joint components.

In a further embodiment, the electrical machine further includes at least one joint spacer arranged within the at least one gap.

In yet another embodiment, the at least one joint spacer includes a carrying portion and a contacting portion.

In another further embodiment, the carrying portion is constructed of at least one of a metal alloy and the contacting portion is constructed of at least one of a metal alloy.

In still another embodiment, the contacting portion is detachable from the carrying portion.

In still a further embodiment, the male joint component includes a radius of curvature of about 10 millimeters to about 50 millimeters.

In yet still another embodiment, the female joint component includes a radius curvature of about 10 millimeters to about 50 millimeters.

In still another further embodiment, each of the plurality of coil support structures further includes a first end and a second end, wherein the male and female joint components extend from the first end to the second end.

In yet a further embodiment, the electrical machine further includes at least one shim arranged between the first and second ends of the adjacent coil support structures.

In still yet another embodiment, each of the plurality of coil support structures further includes a second face, wherein the second face includes one or more support structures configured for mounting a torque tube support structure.

In still yet a further embodiment, a width of one or more of the plurality of coil support structures tapers between the first faces and the second faces.

In yet still a further embodiment, each of the plurality of coil support structures is coated with a coating material.

In yet still another further embodiment, the coating material includes at least one of polytetrafluoroethylene (PTFE) or acetal homopolymer to provide dry lubrication.

In yet another further embodiment, the electrical machine is a superconducting generator and the plurality of conducting coils is a plurality of superconducting coils.

In another aspect, the present disclosure is directed to a coil support structure for a coil support assembly of an electric machine. The coil support structure includes a first face defining a cavity for receiving a superconducting coil; a second face opposite the first face; a first side including a male joint component; and a second side opposite the first side and including a female joint component, wherein the male and female joint components are securable to adjacent coil support structures of the coil support assembly to form multiple joint structures, and wherein, when arranged together, the coil support structure and the adjacent coil support structures form the coil support assembly having a generally circumferential arrangement.

In still another aspect, the present disclosure is directed to a superconducting coil assembly for a superconducting generator. The superconducting coil assembly includes a plurality of coil support structures for receiving a plurality of superconducting coils, the plurality of coil support structures arranged together in a generally circumferential arrangement, wherein each of the plurality of coil support structures includes a first face defining a cavity for receiving one of the plurality of superconducting coils, and opposing sides each including a joint component, wherein joint components of adjacent coil support structures include corresponding male and female joint components secured together to form a joint structure.

In an embodiment, the joint structure is a dovetail joint.

In another embodiment, the joint structure defines at least one gap between the male and female joint components, and wherein the superconducting coil assembly further includes at least one joint spacer arranged within the at least one gap.

These and other features, aspects and advantages of the present disclosure will become better understood with reference to the following description and appended claims. The accompanying drawings, which are incorporated in and constitute a part of this specification, illustrate embodiments of the disclosure and, together with the description, serve to explain the principles of the disclosure.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 illustrates a side, perspective view of an embodiment of a wind turbine according to the present disclosure;

FIG. 2 illustrates an internal, perspective view of an embodiment of a nacelle of the wind turbine of FIG. 1 according to the present disclosure;

FIG. 3 illustrates a partial, perspective view of an embodiment of an electrical machine according to the present disclosure;

FIG. 4 illustrates a perspective view of an embodiment of a coil support assembly of an electrical machine according to the present disclosure;

FIG. 5a illustrates a perspective view of an embodiment of a first side of a coil support structure with a conducting coil arranged therein according to the present disclosure;

FIG. 5b illustrates a perspective view of an embodiment of a second side of a coil support structure according to the present disclosure;

FIG. 6 illustrates a side view of an embodiment of a coil support structure according to the present disclosure;

FIG. 7 illustrates a partial, side view of an embodiment of a coil support assembly at a joint between adjacent coil support structures according to the present disclosure;

FIGS. 8a-8b illustrate side views of various embodiments of joint structures between adjacent coil support structures of a coil support assembly according to the present disclosure;

FIGS. 9a-9b illustrate various views of an embodiment of a coil support structure of a coil support assembly according to the present disclosure;

FIG. 10 illustrates a side view of an embodiment of a coil support assembly of an electrical machine, particularly illustrating sections of the coil support assembly assembled together according to the present disclosure;

FIG. 11 illustrates a flow diagram of an embodiment of a method of assembling a coil support assembly according to the present disclosure; and

FIG. 12 illustrates a flow diagram of an embodiment of a method of assembling a coil support structure according to the present disclosure.

### DETAILED DESCRIPTION

Reference now will be made in detail to embodiments of the disclosure, one or more examples of which are illustrated in the drawings. Each example is provided by way of explanation of the disclosure, not limitation of the disclosure. In fact, it will be apparent to those skilled in the art that various modifications and variations can be made in the present disclosure without departing from the scope or spirit of the disclosure. For instance, features illustrated or described as part of one embodiment can be used with another embodiment to yield a still further embodiment. Thus, it is intended that the present disclosure covers such modifications and variations as come within the scope of the appended claims and their equivalents.

As used herein, the terms “first”, “second”, and “third” may be used interchangeably to distinguish one component from another and are not intended to signify location or importance of the individual components.

The terms “coupled,” “fixed,” “attached to,” and the like refer to both direct coupling, fixing, or attaching, as well as indirect coupling, fixing, or attaching through one or more intermediate components or features, unless otherwise specified herein.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

In general, the present disclosure is directed to an electrical machine, such as a superconducting generator, that includes a coil support assembly composed of multiple coil support structures arranged together in a generally circumferential arrangement. Further, each coil support structure is configured to receive one of a plurality of superconducting coils. Though the present disclosure is described herein with reference to a superconducting generator in general, and more particularly to a wind turbine superconducting generator, the present disclosure is not limited to superconducting generators. For example, the present disclosure can be employed with any electrical machine that includes a coil support assembly composed of coil support structures.

More specifically, each of the coil support structures includes a first face defining a cavity for receiving one of the plurality of conducting coils and opposing sides each having a joint component. In particular, joint components of adjacent coil support structures may include corresponding male and female joint components secured together at a joint structure.

Thus, an advantage of the present disclosure is the reduction or elimination of fasteners required to assemble a coil support assembly. Specifically, the reduction or elimination of fasteners may improve the overall resiliency of the coil support assembly and the coil support structures. In particular, by reducing or eliminating the need for fasteners, the coil support assembly is less susceptible to potential mechanical failure. Another advantage includes ease of assembly and disassembly of the coil support structures due to the interlocking male and female joint components (i.e., the connection is simpler and requires less component parts). Particularly, by designing the male and female joint components of respective coil support structures with specific shapes, the male and female joint components may interlock with each other and be easily assembled. Thus, the assembly of coil support structures may be more streamlined as a result of utilizing male and female joint components according to the present disclosure. Utilizing coil support structures with joint components as described herein according to the present disclosure provides, at least, the aforementioned advantages.

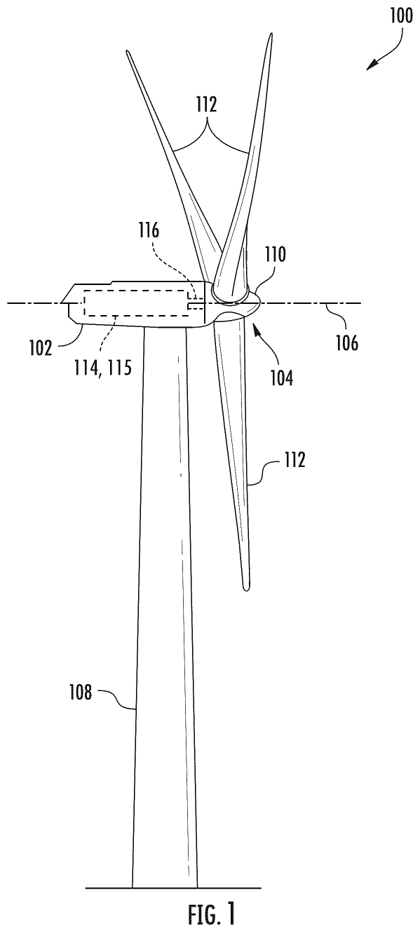

Referring now to the drawings, FIG. 1 illustrates a side, perspective view of a wind turbine 100 having an electrical machine 114, such as a generator 115 according to the present disclosure. As further explained herein, the generator 115 may be a superconducting generator. As shown, the wind turbine 100 generally includes a tower 108 extending from a support surface, a nacelle 102 mounted on the tower 108, and a rotor 104 coupled to the nacelle 102. The rotor 104 includes a rotatable hub 110 and at least one rotor blade 112 (three are shown) coupled to and extending outwardly from the hub 110. Each rotor blade 112 may be spaced about the hub 110 to facilitate rotating the rotor 104 about an axis of rotation 106 to enable kinetic energy to be transferred from the wind into usable mechanical energy, and subsequently, electrical energy. For this purpose, the rotor 104 is coupled to the generator 115 via a shaft (not shown). For purposes of the present disclosure, the generator 115 is a direct drive superconducting generator.

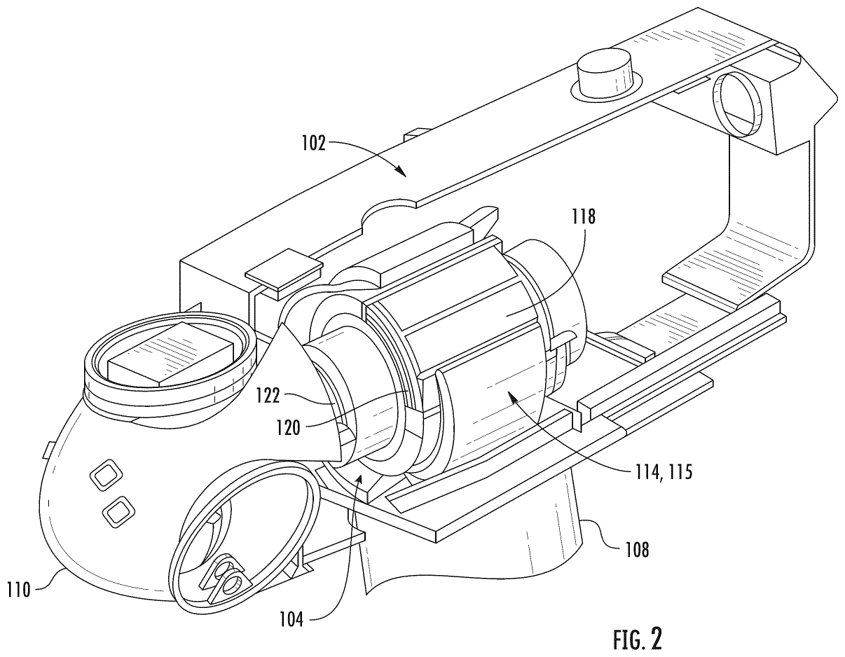

Referring now to FIG. 2, a simplified, internal view of the nacelle 102 of the wind turbine 100 shown in FIG. 1 is illustrated according to the present disclosure. As shown, the electrical machine 114 or the generator 115 is housed within the nacelle 102 and includes a field assembly 120 and an armature 118. Moreover, as shown, the generator 115 is generally coupled to the rotor 104 for producing electrical power from the rotational energy generated by the rotor 104. For example, as shown, the rotor 104 may include a rotor shaft 122 coupled to the hub 110 for rotation therewith. The rotor shaft 122 may, in turn, be rotatably coupled to a armature 118 of the generator 115. As is generally understood, the rotor shaft 122 may provide a torque input to the armature of the generator 115 in response to rotation of the rotor blades 112 and the hub 110.

Electrical power may then be generated using the commonly known principles of induction by applying a torque input to the armature 118 of the generator 115. The armature 118 may then spin within a magnetic field provided by the field assembly 120 of the generator 115 (e.g., in an internal rotor configuration). However, the outer component may be the armature 118 of the generator 115, and the inner component may be the field assembly 120 of the generator 115 (e.g., in an external rotor configuration). Further, as shown, additional space may be defined between the outer component and the inner component so as to allow movement (e.g., rotation) therebetween. It should be understood that the armature 118 may also be the stationary element operating within a rotating magnetic field established by rotation of the field winding.

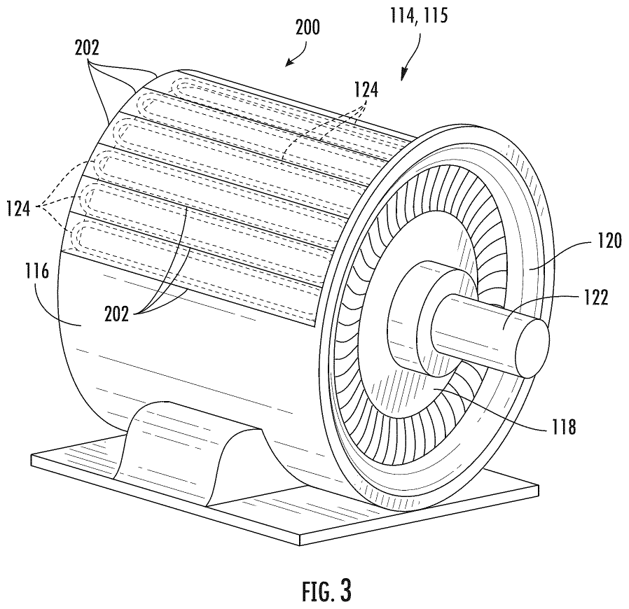

Referring still to FIG. 2, the magnetic field generated by the armature 118 may be due to the magneto-motive force (MMF) setup by the current which flows through the armature 118 (as shown in FIGS. 2 and 3). The MMF has both spatial and temporal harmonics associated with it due to the discretization of the coils and the magnetic saturation within the steel structures, and current harmonics imposed by the electronic converter feeding the armature (not shown).

Referring now to FIG. 3, a cutaway, perspective view of an embodiment of the electrical machine 114 or generator 115 according to the present disclosure is provided. In particular, as shown, the generator 115 may include a housing 116 for housing the internal components thereof, e.g., such as the armature 118 described herein that may be secured to the rotor shaft 122 and the field assembly 120 that may be secured to the stationary housing 116. Moreover, as shown, the superconducting generator 115 may also include at least one winding set. For example, as shown, the winding set(s) may include one or more current carrying conductors formed into coils 124, such as superconducting coils, that may be attached to a coil support assembly, such as the armature 118 or the field assembly 120. Furthermore, the generator 115 may also include a coil support assembly 200 having a plurality of coil support structures 202 that each contain one or more of the coils 124 as will be discussed in greater detail hereinbelow.

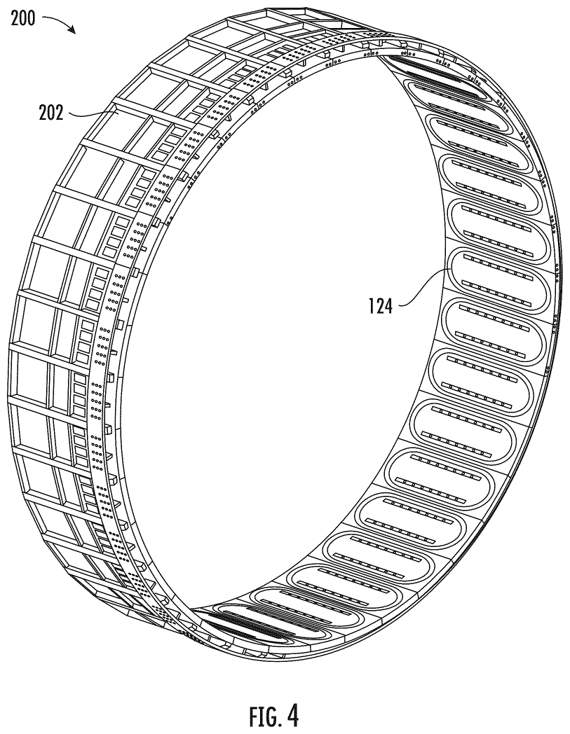

Referring now to FIG. 4, a perspective view of an embodiment of the coil support assembly 200 of an electrical machine (such as the generator 115) is illustrated. As shown, the coil support assembly 200 includes the coil support structures 202 and coils 124, such as superconducting coils, arranged therein. Further, as shown, the coil support structures 202 may be joined or arranged together such that the coil support assembly 200 has a generally circumferential arrangement. Thus, in an embodiment, the circumferential arrangement may generally correspond to a shape of a magnetic field required when operating the generator 115. Accordingly, in an embodiment, the circumferential arrangement allows for the magnetic field produced by the armature 118 to work in concert with the magnetic field produced by the field assembly 120 to produce torque and convert mechanical energy into electrical energy.

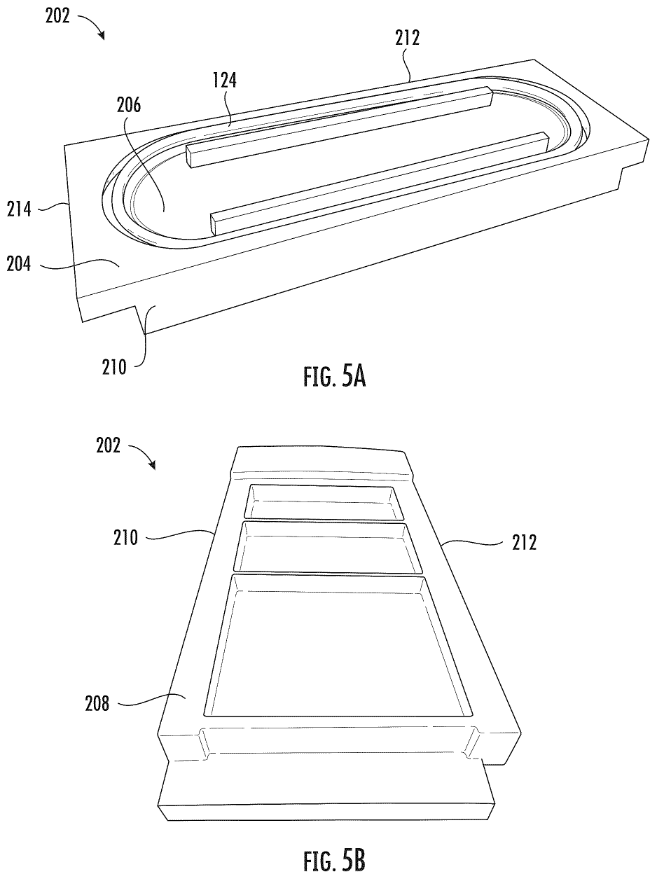

Referring now to FIGS. 5a-5b, various views of an embodiment of one of the coil support structures 202 according to the present disclosure are illustrated. As shown in FIG. 5a, for example, the coil support structure 202 includes a first face 204 defining a cavity 206 for receiving one of the coils 124. In particular, as shown, the cavity 206 generally has an oval or racetrack shape. However, it should be understood that the cavity 206 may have any other suitable shape and is not limited to the illustrated embodiment. Moreover, as shown in FIG. 5b, the coil support structure 202 includes a second face 208 opposite the first face 204. In addition, as shown in FIGS. 5a-5b, the coil support structure 202 further includes a first side 210 and a second side 212 opposite the first side 210.

In further embodiments, the coil support structure(s) 202 may be formed from a variety of materials using a variety of methods. For example, the coil support structure 202 may be formed from a metal such as a metal alloy, or more specifically, an aluminum alloy or an austenitic stainless steel. Further, the coil support structure 202 may be formed via a casting from a mold, such as a sand cast mold.

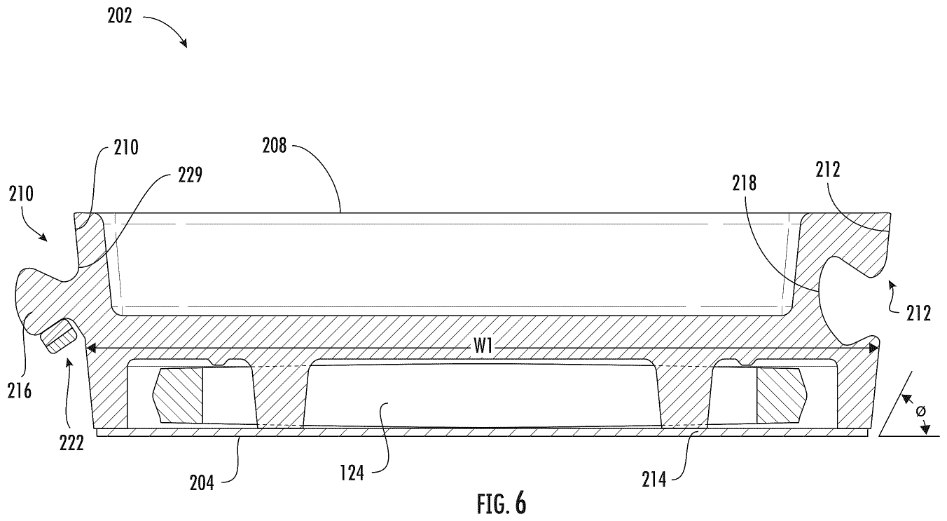

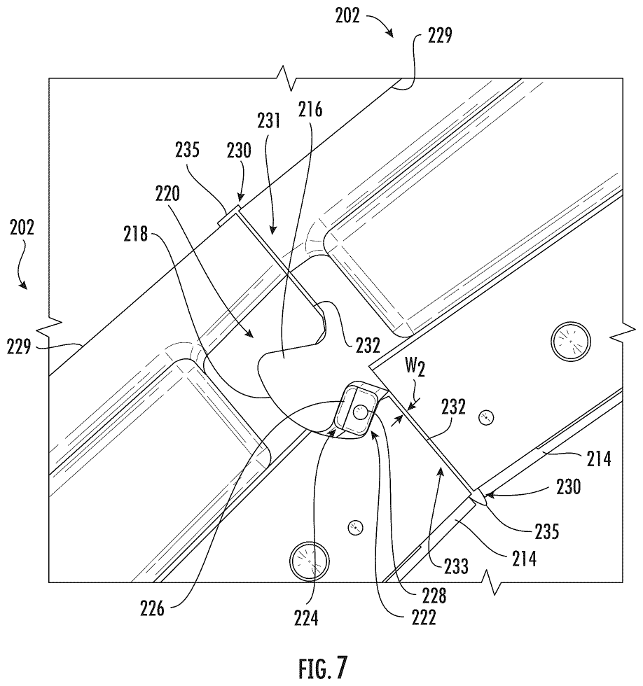

In still further embodiments, the coil support assembly 200 may include one or more support plates 214 arranged on the first face 204 and over the coil 124 such that the coil 124 is enclosed within the coil support structure 202. (See FIGS. 6-7).

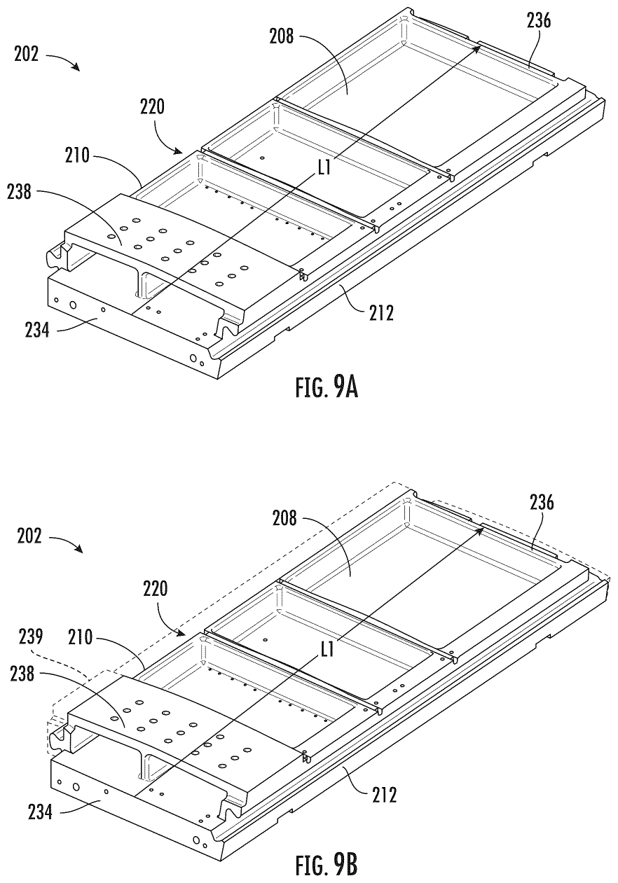

Referring now to FIG. 6, a side view of an embodiment of one of the coil support structures 202 according to the present disclosure is illustrated. As shown, the first side 210 and the second side 212 each include joint components 216, 218, specifically a male joint component 216 and a female joint component 218. Thus, as shown in FIG. 7, when adjacent coil support structures 202 including male and female joint components 216, 218 are secured together, the male and female joint components 216, 218 of adjacent coil support structures 202 together form a joint structure 220. In further embodiments, as shown in FIGS. 9a and 9b, for example, the male and female joint components 216, 218 may span an entirety of the length of the coil support structure 202 as will be discussed in greater detail hereinbelow.

In particular embodiments, the male and female joint components 216, 218 may have a variety of cross-sectional shapes. For example, in an embodiment, the male and female joint components 216, 218 may together form a dovetail joint including a tongue and groove shape, respectively. A dovetail joint is particularly advantageous when used with the coil support structures 202 because they assemble easily and more quickly while distributing stress more evenly than threaded fasteners. In addition, dovetails make aligning adjacent coil support structures straightforward. For example, because a dovetail joint only consists of two parts, it allows for the simplified design of coil support structure that only include a male joint component 216 and a female joint component 218. Further, each coil support structure 202 can be inserted into a defined slot from one end.

In further embodiments, the male joint component 216 may have a radius of curvature ranging from about 2.5 millimeters (mm) to about 100 mm, such as about 5 mm to about 75 mm, such as about 10 mm to about 50 mm. Similarly, the female joint component 218 may have a radius of curvature ranging from about 2.5 millimeters (mm) to about 100 mm, such as about 5 mm to about 75 mm, such as about 10 mm to about 50 mm.

Referring now to FIG. 7, the male and female joint components 216, 218 may be designed such that a gap 224 may exist between adjacent coil support structures 202. For example, if the male joint component 216 has smaller radius of curvature than the female joint component 218, the gap 224 may exist when the joint components 216, 218 are joined to each other. Further, by providing the gap 224, assembly of the male and female joint components 216, 218 may be simplified. For example, the male joint component 216 with a smaller radius of curvature may be more easily placed within the female joint component 218 with a larger radius of curvature.

Moreover, as shown, the coil support assembly 200 may include a joint spacer 222 arranged in the gap 224 between adjacent coil support structures 202. Thus, in an embodiment, the joint spacer 222 is configured to lock the two coil support structures 202 together while distributing interface stress uniformly over the length of the joint. Specifically, by providing the joint spacer 222, the friction between the coil support structures 202 may be reduced by eliminating relative motion of the coil support structures 202. Further, the joint spacer 222 may help account for any extra space that exists between the coil support structures 202 when the joint structure 220 is formed.

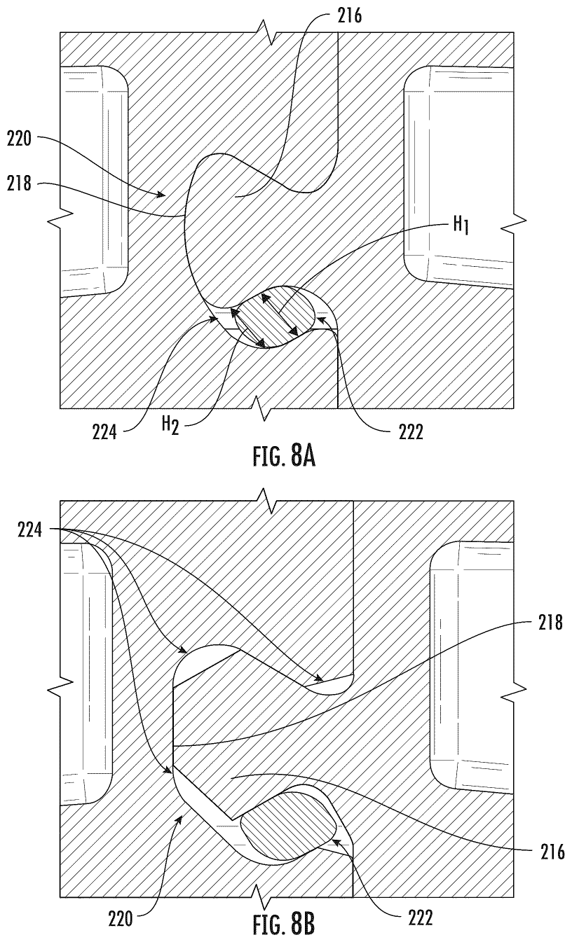

The joint spacer 222 may be sized such that it is smaller than the gap 224. For example, the joint spacer 222 may include a maximum height H1 and the gap 224 may include a maximum height H2. (See FIG. 8A). Here, the maximum height H1 of the joint spacer 222 may be smaller than the maximum height H2 of the gap 224. Specifically, the height H1 may range from about 80% to 99% of the height of H2, such as about 85% to 97.5%, such as about 90% to about 95%. By sizing the joint spacer 222 to be smaller than the gap 224, the joint structure 220 may be locked more easily.

Furthermore, the joint spacer 222 may be formed of multiple portions, such as a carrying portion 226 and a contacting portion 228. More specifically, the carrying portion 226 may be secured or affixed to one of the joint components 216, 218 of the coil support structure 202. Furthermore, in an embodiment, the carrying portion 226 may be formed from a variety of materials. However, in an exemplary embodiment, the carrying portion 226 may be constructed of at least one of a metal alloy such as an aluminum alloy or an austenitic stainless steel. It will be appreciated that temperature effects can be reduced by making the carrying portion 226 and the contacting portion 228 of the same material as the coil support structure 202.

The carrying portion 226 and contacting portion 228 may have a variety of cross sections that interlock with each other. For example, the carrying portion 226 and the contacting portion 228 may each have a wedge shape that interlocks to form the joint spacer 222. For example, when the two wedge shapes are interlocked, they may form a joint spacer 222 having a rectangular shape. The shape of the wedges or the joint spacer 222 may also be further modified with chamfers, bevels, fillets, or the like such that the joint spacer 222 fits within the gap 224. Further, the shapes of the contacting and carrying portion 226, 228 may be individually sized such that they fit within the gap 224 as described above in reference to the height H1 and height H2.

Once the carrying portion 226 is affixed to the joint component 216, 218, the contacting portion 228 may then be attached to the carrying portion 226 such that a tight fit is formed between the joint components 216, 218 when adjacent coil support structures 202 are attached to each other. As such, in an embodiment, the contacting portion 228 may be detachable or removable from the carrying portion 226. By providing the joint spacer 222 with such a configuration, the contacting portion 228 of the joint spacer 222 may be removed during, e.g., maintenance of the coil support assembly 200 or one or more individual coil support structures 202.

Further, in an embodiment, the contacting portion 228 may be easily removed and replaced with another contacting portion 228. Such removal can be advantageous if the joint spacer 222 undergoes stress or mechanical deformation that renders the contacting portion 228 inoperable when contacting with the joint components 216, 218 during operation of the electrical machine 114 or the generator 115. Like the carrying portion 226, the contacting portion 228 may be formed from a variety of materials. However, in an exemplary embodiment, the contacting portion 228 may be constructed of at least one of a metal alloy such as an aluminum alloy or an austenitic stainless steel. It will be appreciated that installation of the carrying portion 226 and the contacting portion 228 is simplified if each is tapered so that engagement over the entire length happens uniformly.

To further improve the mechanical properties between the coil support structures 202 and alleviate mechanical stresses therebetween, the coil support structures 202 may further be coated with a coating material 229. For example, the coating material 229 may include at least one of polytetrafluoroethylene (PTFE) or acetal homopolymer to provide dry lubrication as the carrying portion 226 and contacting portion 228 are installed. Further, the coating material 229 may include an anodization of a metal such as aluminum. Such an anodization may make the coil support structure 202 more wear resistant, corrosion resistant, providing surface lubricity, and prevent galling between the coil support structures 202.

Referring back to FIG. 6, each of the coil support structures 202 may taper in width W1 from the first face 204 to the second face 208 or vice versa. For example, the width at the first face 204 may be smaller than the width at the second face 208, or vice versa. Further, the taper may include an angle Ø on each side 210, 212 of the coil support structure 202. The angle Ø may range from about 5 degrees to about 20 degrees, such as about 7.5 degrees to about 15 degrees, such as about 10 degrees to about 12.5 degrees. By providing a tapering width W1 between the faces 204, 208, the coil support structures 202 may be capable of being connected in a generally circumferential arrangement when connected to each other with the joint structure 220.

Further, as shown particularly in FIG. 7, the variable width provided by tapering between the faces 204, 208 can be sized such that one or more gaps 230 may be formed between ends of the coils support structures 202 when connected together via the joint structure(s) 220. Advantageously, one or more shims 232 may be placed within the gaps 230. Specifically, the shim(s) 232 may be placed within the gaps 230 such that a contact surface 231, 233 of the coil support structures do not contact each other except at the male and female joint components 216, 218. By providing the shim(s) 232 within the gap(s) 230, further dry lubrication may be provided between the coil support structures 202, thereby reducing overall mechanical stresses therebetween. Specifically, the shim(s) 232 may reduce the friction between the coil support structures 202 when provided within the gap(s) 230. Further, shim(s) 232 may help account for any extra space found between coil support structures 202 when the joint structure 220 is formed.

The shim(s) 232 may be formed from a variety of materials such as at least one a metal alloy such as an aluminum alloy or austenitic stainless steel. It will be appreciated that magnetic materials may unfavorably distort the magnetic fields produced by the field coils. In an exemplary embodiment, the shims are formed from a stainless steel to provide rigidity when inserting the shim(s) 232 within the gap(s) 230.

Further, if more than one shim 232 is used, the shims 232 may have the same or substantially the same width W2. By providing shims 232 with the same or substantially the same width W2 angular forces applied within the joint structure 220 can be reduced that would effect the integrity of the joint structure 220.

The shim(s) 232 may also include an extension 235 that extends outside of the gaps 230. The extension 235 may include a lip, a protrusion, a tab, or other similar features. By providing such an extension 235, the shim(s) may be more easily removed or the positioning of the shim(s) 232 within the gaps 230 may be adjusted if required.

Referring now to FIGS. 8a-8b, side views of various embodiments of the joint structures 220 according to the present disclosure are illustrated. Particularly, referring to FIG. 8a, the male and female joint components 216, 218 of the joint structure 220 each have a generally arcuate cross-sectional shape arranged together such that gap 224 is formed having the joint spacer 222 placed therein. Referring to FIG. 8b, the male and female joint components 216, 218 of the joint structure 220 are arranged together such that multiple gaps 224 are formed therebetween. In such an embodiment, the joint spacer 222 is also placed in one of the gaps 224.

Referring now to FIGS. 9a-9b, various views of an embodiment of the coil support structure 202 are illustrated. As shown, the male and female joint components 216, 218 described herein may span an entirety of a length L1 of the coil support structure 202. Specifically, the coil support structures 202 may include a first end 234 and a second end 236 with the male and female joint components 216, 218 extending from the first end 234 to the second end 236.

Still referring to FIGS. 9a-9b, the coil support structure 202 may also include one or more support structures 238. In such embodiments, the support structure(s) 238 may be designed such that a torque tube or torque tube support structure (not shown) can be readily attachable to the support structure(s) 238. Thus, a torque tube or torque tube support structure may be securable to each of the coil support structures 238. Further, the support structures(s) 238 may be securable to each other. For example, as shown in FIG. 9b, the support structure 238 may align with another support structure 239 along the joint structure 220.

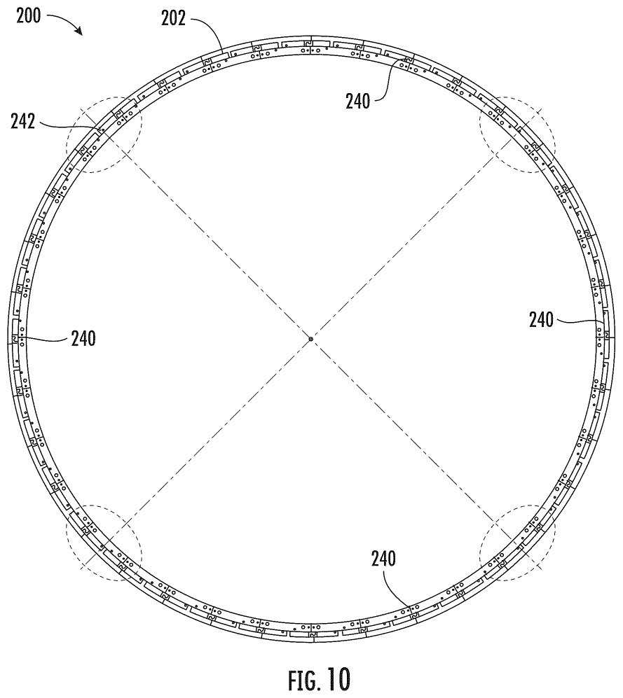

Referring now to FIG. 10, a side view of an embodiment of the coil support assembly 200 described herein is illustrated. In particular, as shown, the coil support assembly may include one or more sections 240 assembled together according to the present disclosure. The sections 240 can be composed of multiple individual coil support structures 202. Thus, in such embodiments, the sections 240 can be joined together to form the coil support assembly 200. Each section 240 may define a specific portion of a 360-degree angle of a circumferential arrangement of the coil support assembly 200. In particular, one section 240 may define an arc having an angle ranging from about 5 degrees to about 200 degrees, such as about 7.5 degrees to about 190 degrees, such as about 10 degrees to about 180 degrees. Furthermore, as shown, adjacent sections 240 may be secured together via a connecting member 242. For example, in an embodiment, the connecting member 242 may be the joint structure 220 or the shim(s) 232 as described hereinabove.

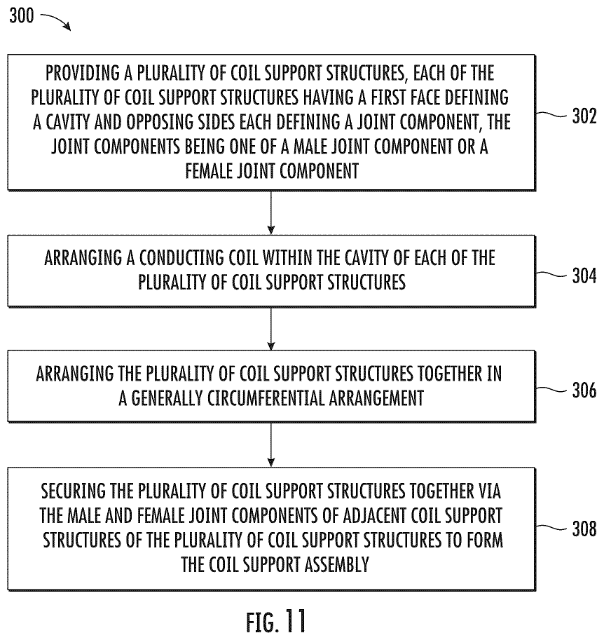

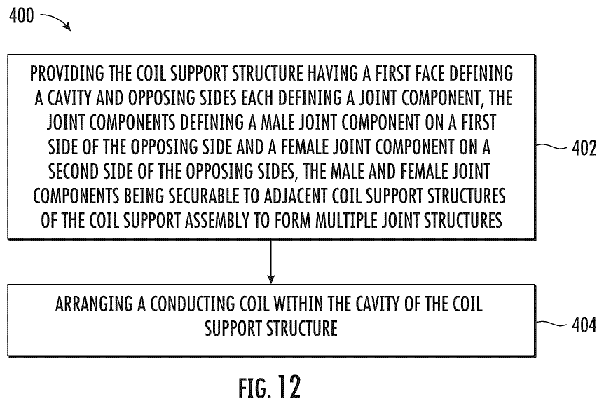

Referring now to FIGS. 11-12, various methods of assembly are provided. In particular, FIG. 11 provides a flow diagram of an embodiment of a method 300 of assembling a coil support assembly, such as the coil support assembly 200. Further, FIG. 12 provides a flow diagram of an embodiment of a method 400 of assembling a coil support structure, such as coil support structure 202. It should be understood that the methods 300, 400 may be implemented using, for instance, the electrical machine 114 or the generator 115 of the present disclosure discussed above with references to FIGS. 1-10. FIGS. 11-12 depict steps performed in a particular order for purposes of illustration and discussion. Those of ordinary skill in the art, using the disclosure provided herein, will understand that various steps of the methods 300, 400, or any of the methods disclosed herein, may be adapted, modified, rearranged, performed simultaneously, or modified in various ways without deviating from the scope of the present disclosure.

Referring to FIG. 11, as shown at (302), the method 300 includes providing a plurality of coil support structures, each of the plurality of coil support structures having a first face defining a cavity and opposing sides each defining a joint component, the joint components being one of a male joint component or a female joint component. Further, as shown at (304), the method 300 includes arranging a conducting coil within the cavity of each of the plurality of coil support structures. Further, as shown at (306), the method 300 includes arranging the plurality of coil support structures together in a generally circumferential arrangement. Further, as shown at (308), the method 300 includes securing the plurality of coil support structures together via the male and female joint components of adjacent coil support structures of the plurality of coil support structures to form the coil support assembly.

Moreover, the method 300 may further include the step of arranging at least one joint spacer within the at least one gap. If a joint spacer is provided, it should be understood that the joint spacer may be secured to the male joint component before the male joint component is secured with a female joint component. However, it should be also understood that the joint spacer may alternatively be placed within the female joint component before the female joint component is secured with the male joint component. The joint spacer may include a carrying portion and a contacting portion where the carrying portion is secured to the male or female joint components and the contacting portion is secured to the carrying portion after installation.

Moreover, the method 300 may also include a maintenance operation for the coil support assembly formed via the method 300. In particular, the method 300 may also include the step of removing the contacting portion from the carrying portion during a maintenance operation and replacing the contacting portion with another contacting portion.

Referring now to FIG. 12, as shown at (402), the method 400 includes providing a coil support structure having a first face defining a cavity and opposing sides each defining a joint component, the joint components defining a male joint component on a first side of the opposing side and a female joint component on a second side of the opposing sides, the male and female joint components being securable to adjacent coil support structures of the coil support assembly to form multiple joint structures. Further, as shown at (404), the method 400 includes arranging a conducting coil within the cavity of the coil support structure. Specifically, when arranged together, the coil support structure and an adjacent coil support structures form a coil support assembly having a generally circumferential arrangement.

Various aspects and embodiments of the present disclosure are defined by the following numbered clauses:
Clause 1. An electrical machine, comprising:
   a coil support assembly comprising a plurality of coil support structures for receiving a plurality of conducting coils, the plurality of coil support structures arranged together in a generally circumferential arrangement,
   wherein each of the plurality of coil support structures comprises:
   a first face defining a cavity for receiving one of the plurality of conducting coils; and
   opposing sides each comprising a joint component,
   wherein joint components of adjacent coil support structures comprise corresponding male and female joint components secured together at a joint structure.
Clause 2. The electrical machine of clause 1, wherein the joint structure comprises a dovetail joint.
Clause 3. The electrical machine any one of clauses 1 to 2, wherein the joint structure defines at least one gap between the male and female joint components.
Clause 4. The electrical machine of clause 3, further comprising at least one joint spacer arranged within the at least one gap.
Clause 5. The electrical machine of clause 4, wherein the at least one joint spacer comprises a carrying portion and a contacting portion.
Clause 6. The electrical machine of clause 5, wherein the carrying portion is constructed of at least one of a metal alloy and the contacting portion is constructed of at least one of a metal alloy.
Clause 7. The electrical machine of any one of clauses 5 to 6, wherein the contacting portion is detachable from the carrying portion.
Clause 8. The electrical machine of any one of the preceding clauses, wherein the male joint component comprises a radius of curvature of about 10 millimeters to about 50 millimeters.
Clause 9. The electrical machine of any one of the preceding clauses, wherein the female joint component comprises a radius curvature of about 10 millimeters to about 50 millimeters.
Clause 10. The electrical machine of any one of the preceding clauses, wherein each of the plurality of coil support structures further comprises a first end and a second end, wherein the male and female joint components extend from the first end to the second end.
Clause 11. The electrical machine of clause 10, further comprising at least one shim arranged between the first and second ends of the adjacent coil support structures.
Clause 12. The electrical machine of any one of the preceding clauses, wherein each of the plurality of coil support structures further comprises a second face, wherein the second face comprises one or more support structures configured for mounting a torque tube support structure.
Clause 13. The electrical machine of any one of the preceding clauses, wherein a width of one or more of the plurality of coil support structures tapers between the first faces and the second faces.
Clause 14. The electrical machine of any one of the preceding clauses, wherein each of the plurality of coil support structures is coated with a coating material.
Clause 15. The electrical machine of clause 14, wherein the coating material comprises at least one of polytetrafluoroethylene (PTFE) or acetal homopolymer to provide dry lubrication.
Clause 16. The electrical machine of any one of the preceding clauses, wherein the electrical machine is a superconducting generator and the plurality of conducting coils is a plurality of superconducting coils.
Clause 17. A coil support structure for a coil support assembly of an electric machine, the coil support structure comprising:
   a first face defining a cavity for receiving a superconducting coil;
   a second face opposite the first face;
   a first side comprising a male joint component; and
   a second side opposite the first side and comprising a female joint component,
   wherein the male and female joint components are securable to adjacent coil support structures of the coil support assembly to form multiple joint structures, and
      wherein, when arranged together, the coil support structure and the adjacent coil support structures form the coil support assembly having a generally circumferential arrangement.
Clause 18. A superconducting coil assembly for a superconducting generator, comprising:
   a plurality of coil support structures for receiving a plurality of superconducting coils, the plurality of coil support structures arranged together in a generally circumferential arrangement,
   wherein each of the plurality of coil support structures comprises:
   a first face defining a cavity for receiving one of the plurality of superconducting coils, and
   opposing sides each comprising a joint component,
   wherein joint components of adjacent coil support structures comprise corresponding male and female joint components secured together to form a joint structure.
Clause 19. The superconducting coil assembly of clause 18, wherein the joint structure is a dovetail joint.
Clause 20. The superconducting coil assembly of any one of clauses 18 to 19, wherein the joint structure defines at least one gap between the male and female joint components, and wherein the superconducting coil assembly further comprises at least one joint spacer arranged within the at least one gap.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An electrical machine, comprising:
a coil support assembly comprising a plurality of coil support structures for receiving a plurality of conducting coils, the plurality of coil support structures arranged together in a generally circumferential arrangement,
wherein each of the plurality of coil support structures comprises:
a first face defining a cavity for receiving one of the plurality of conducting coils; and
opposing sides each comprising a joint component,
wherein joint components of adjacent coil support structures comprise corresponding male and female joint components secured together at a joint structure.

2. The electrical machine of claim 1, wherein the joint structure comprises a dovetail joint.

3. The electrical machine of claim 1, wherein the joint structure defines at least one gap between the male and female joint components.

4. The electrical machine of claim 3, further comprising at least one joint spacer arranged within the at least one gap.

5. The electrical machine of claim 4, wherein the at least one joint spacer comprises a carrying portion and a contacting portion.

6. The electrical machine of claim 5, wherein the carrying portion is constructed of at least one of a metal alloy and the contacting portion is constructed of at least one of a metal alloy.

7. The electrical machine of claim 5, wherein the contacting portion is detachable from the carrying portion.

8. The electrical machine of claim 1, wherein the male joint component comprises a radius of curvature of about 10 millimeters to about 50 millimeters.

9. The electrical machine of claim 1, wherein the female joint component comprises a radius curvature of about 10 millimeters to about 50 millimeters.

10. The electrical machine of claim 1, wherein each of the plurality of coil support structures further comprises a first end and a second end, wherein the male and female joint components extend from the first end to the second end.

11. The electrical machine of claim 10, further comprising at least one shim arranged between the first and second ends of the adjacent coil support structures.

12. The electrical machine of claim 1, wherein each of the plurality of coil support structures further comprises a second face, wherein the second face comprises one or more support structures configured for mounting a torque tube support structure.

13. The electrical machine of claim 1, wherein a width of one or more of the plurality of coil support structures tapers between the first faces and the second faces.

14. The electrical machine of claim 1, wherein each of the plurality of coil support structures is coated with a coating material.

15. The electrical machine of claim 14, wherein the coating material comprises at least one of polytetrafluoroethylene (PTFE) or acetal homopolymer to provide dry lubrication.

16. The electrical machine of claim 1, wherein the electrical machine is a superconducting generator and the plurality of conducting coils is a plurality of superconducting coils.

17. A coil support structure for a coil support assembly of an electric machine, the coil support structure comprising:
a first face defining a cavity for receiving a superconducting coil;
a second face opposite the first face;
a first side comprising a male joint component; and
a second side opposite the first side and comprising a female joint component,
wherein the male and female joint components are securable to adjacent coil support structures of the coil support assembly to form multiple joint structures, and
wherein, when arranged together, the coil support structure and the adjacent coil support structures form the coil support assembly having a generally circumferential arrangement.

18. A superconducting coil assembly for a superconducting generator, comprising:
a plurality of coil support structures for receiving a plurality of superconducting coils, the plurality of coil support structures arranged together in a generally circumferential arrangement,
wherein each of the plurality of coil support structures comprises:
a first face defining a cavity for receiving one of the plurality of superconducting coils, and
opposing sides each comprising a joint component,
wherein joint components of adjacent coil support structures comprise corresponding male and female joint components secured together to form a joint structure.

19. The superconducting coil assembly of claim 18, wherein the joint structure is a dovetail joint.

20. The superconducting coil assembly of claim 18, wherein the joint structure defines at least one gap between the male and female joint components, and wherein the superconducting coil assembly further comprises at least one joint spacer arranged within the at least one gap.
